(19) United States
(12) Patent Application Publication
(10) Pub. No.: US 2015/0160695 A1
(43) Pub. Date: Jun. 11, 2015

(54) HINGE UNIT WITH SIMULTANEOUS ROTATABLE AXLES

(71) Applicant: Yuan Deng Metals Industrial Co., Ltd., Taoyuan (TW)

(72) Inventors: Shun-Chin SU, Taoyuan (TW); Bo-Lun LIN, Taoyuan (TW); Shih-Pin YANG, Taoyuan (TW)

(73) Assignee: Yuan Deng Metals Industrial Co., Ltd., Taoyuan (TW)

(21) Appl. No.: 14/191,818

(22) Filed: Feb. 27, 2014

(30) Foreign Application Priority Data
Dec. 6, 2013 (TW) 102222949

(51) Int. Cl. G06F 1/16; E05D 3/12

(52) U.S. Cl. CPC G06F 1/1618; E05D 3/12

(57) ABSTRACT

A hinge unit includes a coupler plate formed with first and second coupler holes; first and second axles extending rotatably through the coupler holes in the coupler plate and formed with first and second engaging grooves corresponding to each other; a driving slide block disposed between the first and second axles, having first and second contact surfaces formed with first and second engagement ribs in engagement with the first and the second engaging grooves such that the slide block is movable along axes of the axles; and a positioning plate formed with first and second position holes permitting extension of the first and second axles, thereby restricting a movable range of the slide block between the coupler plate and the positioning plate. Movement of the slide block along the axes of the axles results in simultaneous rotation of the axles in directions opposite to each other.

This application claims the benefits of the Taiwan Patent Application Serial NO. 102222949, filed on Dec. 6, 2013, the subject matter of which is incorporated herein by reference.

### BACKGROUND OF THE INVENTION

1. Field of the Invention

The present invention relates to a hinge unit, more particularly to a hinge unit having double axles, which are simultaneous rotatable owing to complementary of engaging grooves and engagement ribs, in which an axial movement along axes of the axles results in simultaneous rotation of the axle. 2. Description of the Prior Art

Rapid development of smart phone of late consequently triggers advance of touch-type electronic devices, such as tablet computer. In order to grasp the market of notebook computer or tablet computer, the manufacturers have developed of late a flexible tablet computer, which generally includes a touch display rotatable about 360 degrees relative to a keyboard so that the touch display can perform a tablet computer. The manufacturers have even developed of late a flexible tablet computer having double touch displays which are foldable relative to each other, thereby serving as a tablet computer.

The two touch displays in a foldable tablet computer are connected relative to each other via a hinge unit in such a manner that when the user rotates one of the touch display, the other touch display is simultaneously rotated in a direction opposite to that of the former, thereby achieving in opening and closing positions of the tablet computer. Presently, in order to achieve the opening and closing of the tablet computer, several gear wheels or pinions are employed, thereby resulting in complication of the device, hence increasing the manufacturing cost and generating a sense of engagement.

### SUMMARY OF THE INVENTION

As stated above, the currently available electronic devices are provided with hinge unit with simultaneous rotation axles so as to achieve the swift closing or opening positions, and since several gear wheels or pinions are required to be employed for simultaneous rotation, thereby resulting in complication of the device, hence increasing the manufacturing cost and generating a sense of engagement.

Therefore, the object of the present invention is to provide a hinge unit having double axles, which are simultaneous rotatable owing to complementary of engaging grooves and engagement ribs, in which an axial movement along axis of one axle results in simultaneous rotation of the other axle.

The hinge unit of the present invention accordingly includes a coupler plate, a first axle, a second axle, a driving slide block and a positioning plate.

The coupler plate is formed with a first coupler hole and a second coupler hole extending parallel to the first coupler hole.

The first axle extends rotatably through the first coupler hole in the coupler plate, and has a first interference section formed with a first engaging groove extending in a first rotation direction of the first axle. The second axle extends rotatably through the second coupler hole in the coupler plate, and has a second interference section formed with a second engaging groove that is in aligned with the first engaging groove and that extends in a second rotation direction opposite to the first rotation direction.

The driving slide block is disposed between the first and second axles, and has a first contact surface formed with a first engagement rib corresponding to and in engagement with the first engaging groove and a second contact surface formed with a second engaging rib corresponding to and in engagement with the second engaging groove such that the slide block is movable along axes of the first and second axles.

The positioning plate is formed with a first position hole permitting extension of the first axle and a second position hole permitting extension of the second first axle, thereby restricting a movable range of the slide block between the coupler plate and the positioning plate.

Movement of the slide block along the axes of the first and second axles results in simultaneous rotation of the first and second axles in directions opposite to each other. In other words, when the user rotates the first axle about its axis in the first rotation direction (by holding the touch display or the CPU), the second axle is rotated about its axis in the second rotation direction opposite to the first rotation direction owing to engagement of the first and second engagement ribs within the engaging grooves in the first and second contact surfaces of the slide block and since the slide block moves along the axes of the first and second axles.

The first axle preferably has a first twisting section extending axially and integrally from one end of the first interference section and a first coupling section extending axially and integrally from the other end of the first interference section.

The first axle further has a first restriction element formed between the first interference section and the first coupling section and in alignment with the interference block of the coupler plate so as to limit a rotation range of the first axle about its axis.

The second axle preferably has a second twisting section extending axially and integrally from one end of the second interference section and a second coupling section extending axially and integrally from the other end of the second interference section. The second axle further has a second restriction element formed between the second interference section and the second coupling section and in alignment with the interference block of the coupler plate so as to limit a rotation range of the second axle about its axis.

As described above, owing to configuration of the first and second interference sections, the first and second axles generate little noise upon rotation since no other elements (such as gear wheels) are mounted on the first and second axles that collide against one other so as to generate noise. In other words, the first and second axles rotate more smoothly and generate little noise since no other elements (such as gear wheels) are mounted on the first and second axles.

The hinge unit of the present invention further includes the twisting member formed by a plurality of stacked twisting plates, a restriction plate and two C-shaped retention clips. The plurality of stacked twisting plates are sleeved around and define first and second pivoting portions, which threadedly engage and permit extension of the first and second twisting sections of the first and second axles therethrough such that the twisting member is confined non-movably between the restriction plate and the positioning plate to provide a torque onto the twisting sections, thereby increasing rotation speed of the first and second axles. The restriction plate is formed with two through holes to permit extension of distal ends of the twisting sections therethrough. The retention clips are mounted in the distal ends of the twisting sections of the first and second axles, thereby preventing untimely removal of the twisting member from the first and second axles.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view of a hinge unit having double axles simultaneously rotatable in accordance with the present invention;

FIG. 2 is an exploded view of the hinge unit of the present invention;

FIG. 3 is a fragmentary enlarged view of the hinge unit of the present invention;

FIG. 4 is a perspective view of the hinge unit of the present invention in operation; and

FIG. 5 is a fragmentary enlarged view of the hinge unit of the present invention in operation.

### DETAILED DESCRIPTION OF THE PREFERRED EMBODIMENTS

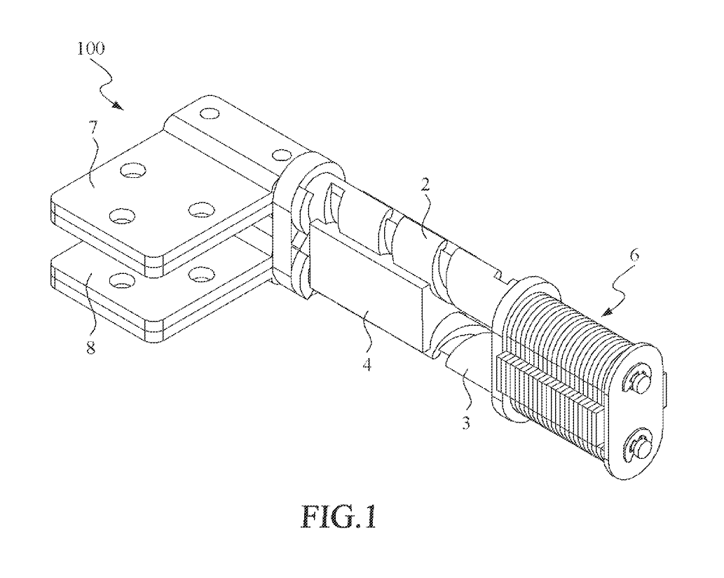

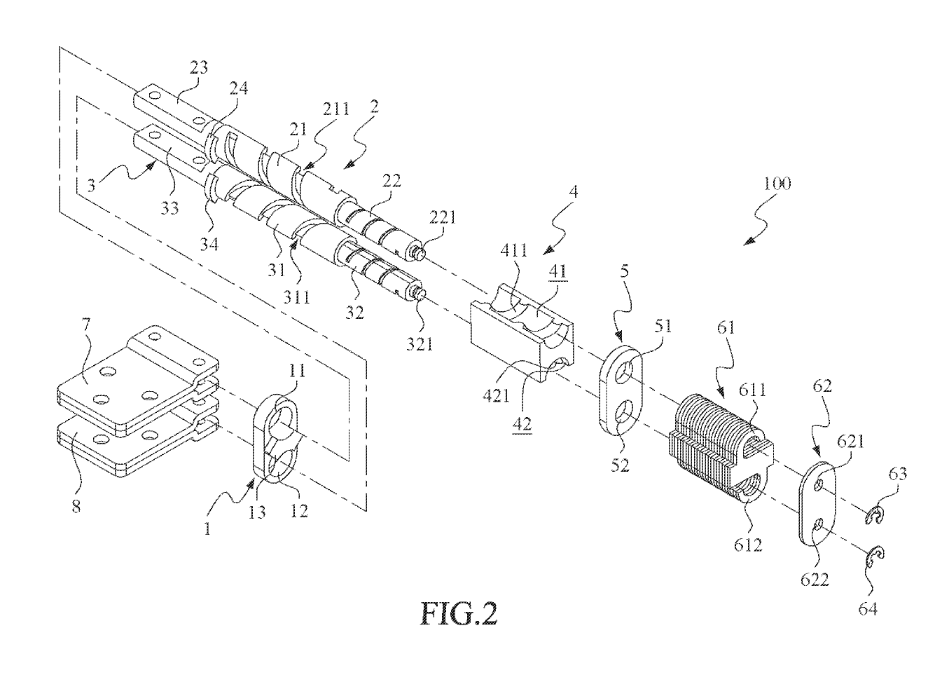

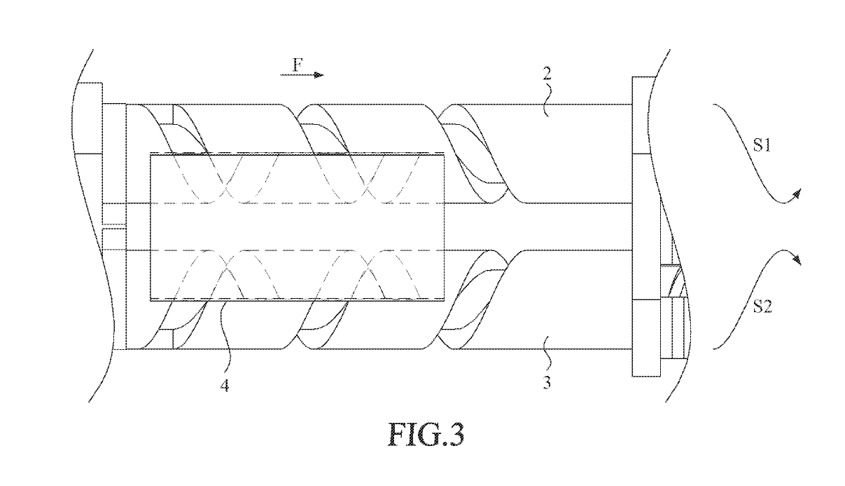

Referring to FIGS. 1 to 3, wherein FIG. 1 is a perspective view of a hinge unit having double axles simultaneously rotatable in accordance with the present invention; FIG. 2 is an exploded view of the hinge unit of the present invention; while FIG. 3 is a fragmentary enlarged view of the hinge unit of the present invention. As illustrated, the hinge unit 100 of the present includes a coupler plate 1, a first axle 2, a second axle 3, a driving slide block 4, a positioning plate 5, a twisting member 6 and a pair of holding plates 7, 8.

As illustrated, the coupler plate 1 formed with a first coupler hole 11 and a second coupler hole 12 extending parallel to the first coupler hole 11. In addition, the coupler plate 1 is further formed with an interference block 13 between the first and second coupler holes 11, 12, the purpose of which will be described in the following paragraphs.

The first axle 2 extends rotatably through the first coupler hole 11 in the coupler plate 1, and has a first interference section 21 formed with a first engaging groove 211 extending in a first rotation direction Si of the first axle 2, a first twisting section 22 extending axially and integrally from one end of the first interference section 21 and a first coupling section 23 extending axially and integrally from the other end of the first interference section 21. The first axle 2 further has a first restriction element 24 formed between the first interference section 21 and the first coupling section 23 and in alignment with the interference block 13 of the coupler plate 1 so as to limit a rotation range of the first axle 2 about its axis.

The second axle 3 extends rotatably through the second coupler hole 12 in the coupler plate 1, and has a second interference section 31 formed with a second engaging groove 311 that is in aligned with said first engaging groove 211 and that extends in a second rotation direction S2 opposite to the first rotation direction S1, a second twisting section 32 extending axially and integrally from one end of the second interference section 31 and a second coupling section 33 extending axially and integrally from the other end of the second interference section 31. The second axle 3 further has a second restriction element 34 formed between the second interference section 31 and the second coupling section 33 and in alignment with the interference block 13 of the coupler plate 1 so as to limit a rotation range of the second axle 3 about its axis.

The driving slide block 4 is disposed between the first and second axles 2,3, and has a first contact surface 41 formed with a first engagement rib 411 corresponding to and in engagement with the first engaging groove 211 and a second contact surface 42 formed with a second engaging rib 411 corresponding to and in engagement with the second engaging groove 311 such that the slide block 4 is movable along axes F of the first and second axles 2,3.

The positioning plate 5 is formed with a first position hole 51 permitting extension of the first axle 2 and a second position hole 52 permitting extension of the second first axle 3, thereby restricting a movable range of the slide block 4 between the coupler plate 1 and the positioning plate 5.

The hinge unit 100 of the present invention further includes the twisting member 6 formed by a plurality of stacked twisting plates 61 (only one is shown in the drawing), a restriction plate 62 and two C-shaped retention clips 63,64. The plurality of stacked twisting plates 61 are sleeved around and define first and second pivoting portions 611, 612 which threadedly engage and permit extension of the first and second twisting sections 22, 32 of the first and second axles 2, 3 therethrough such that the twisting member 6 is confined non-movably between the restriction plate 62 and the positioning plate 5 to provide a torque onto the twisting sections 22, 32, thereby increasing rotation speed of the first and second axles 2, 3.

The restriction plate 62 is formed with two through holes 621, 622 to permit extension of distal ends of the twisting sections 22, 32 therethrough. The retention clips 63,64 are mounted in the annular grooves 221, 321 in the distal ends of the twisting sections 22, 32 of the first and second axles 2,3, thereby preventing untimely removal of the twisting member 6 from the first and second axles 2,3. It is to note that the structure of the retention clips 63,64 should not be limited only to C-shape but should include any other configuration.

The holding plates 7, 8 are coupled securely to the first and second coupling section 21, 31 of the first and second axles 2, 3 so as to hold two electronic components respectively, such as touch display and CPU of a tablet computer.

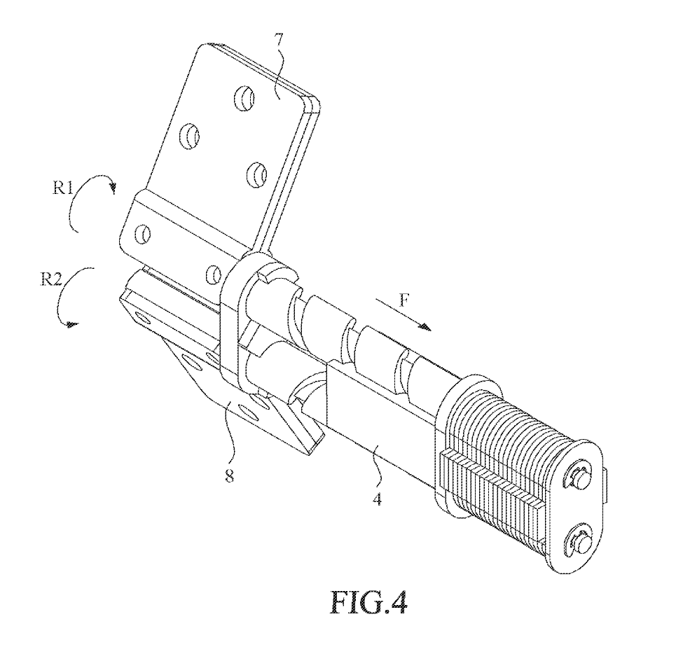

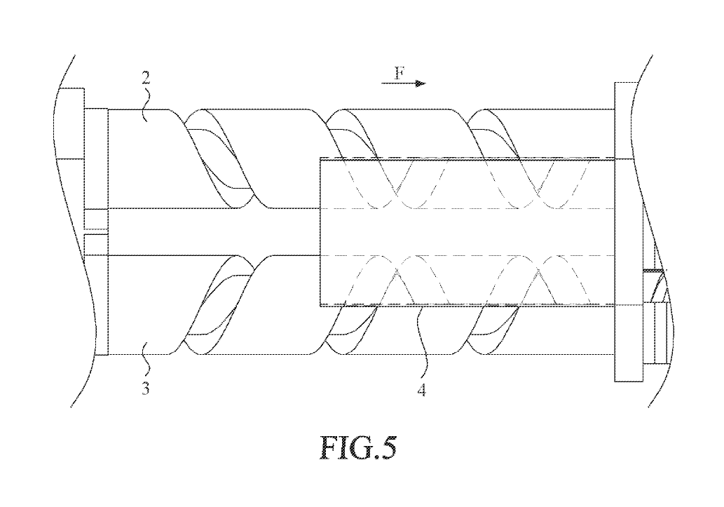

Referring to FIGS. 1-5, wherein FIG. 4 is a perspective view of the hinge unit 100 of the present invention in operation; and FIG. 5 is a fragmentary enlarged view of the hinge unit 100 of the present invention in operation. As illustrated, movement of the slide block 4 along the axes of the first and second axles 2,3 results in simultaneous rotation of the first and second axles 2,3 in directions opposite to each other. In other words, when the user rotates the first axle 2 about its axis in the first rotation direction Si (by holding the touch display or the CPU), the second axle 3 rotates about its axis in the second rotation direction S2 opposite to the first rotation direction Si owing to engagement of the first and second engagement ribs 411, 412 within the engaging grooves 211, 311 in the first and second contact surfaces of the slide block 4 and since the slide block 4 moves along the axes of the first and second axles 2, 3.

As described above, owing to engagement of the first and second engagement ribs 411, 412 of the slide block 4 within the engaging grooves 211, 311 in the first and second axles 2, 3, movement of the slide block 4 along the axes of the first and second axles 2, 3 results in simultaneous rotation of the first and second axles 2, 3 in directions opposite to each other. An important fact to note that no gear wheels or pinions are employed in the hinge unit of the present invention, the manufacturing cost thereof can be reduced.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A hinge unit comprising:
a coupler plate formed with a first coupler hole and a second coupler hole extending parallel to said first coupler hole;
a first axle extending rotatably through said first coupler hole in said coupler plate and formed with a first engaging groove extending in a first rotation direction of said first axle;
a second axle extending rotatably through said second coupler hole in said coupler plate and formed with a second engaging groove that is in aligned with said first engaging groove and that extends in a second rotation direction opposite to said first rotation direction;
a driving slide block disposed between said first and second axles, having a first contact surface formed with a first engagement rib corresponding to and in engagement with said first engaging groove and a second contact surface formed with a second engaging rib corresponding to and in engagement with said second engaging groove such that said slide block is movable along axes of said first and second axles; and
a positioning plate formed with a first position hole permitting extension of said first axle and a second position hole permitting extension of said second first axle, thereby restricting a movable range of said slide block between said coupler plate and said positioning plate;
wherein, movement of said slide block along said axes of said first and second axles results in simultaneous rotation of said first and second axles in directions opposite to each other.

2. The hinge unit according to claim 1, wherein said first axle has a first interference section formed with said first engaging groove, a first twisting section extending axially from one end of said first interference section and a first coupling section extending axially from the other end of said first interference section.

3. The hinge unit according to claim 2, wherein said first axle further has a first restriction element formed between said first interference section and said first coupling section, said coupler plate further being formed with an interference block corresponding to said first restriction element so as to limit a rotation range of said first axle about its axis.

4. The hinge unit according to claim 2, wherein said second axle has a second interference section formed with said second engaging groove, a second twisting section extending axially from one end of said second interference section and a second coupling section extending axially from the other end of said second interference section.

5. The hinge unit according to claim 4, wherein said second axle further has a second restriction element formed between said second interference section and said second coupling section, said coupler plate further being formed with an interference block corresponding to said second restriction element so as to limit a rotation range of said second axle about its axis.

6. The hinge unit according to claim 4, further comprising a twisting member formed by a plurality of stacked twisting plates, a restriction plate and two retention clips, said plurality of stacked twisting plates being sleeved threadedly around said first and second twisting sections of said first and second axles such that the twisting member is confined non-movably between said restriction plate and said positioning plate, said retention clips being mounted on distal ends of said first and second twisting sections of said first and second axles, thereby preventing untimely removal of said twisting member from said first and second axles.
